(19) United States
(12) Patent Application Publication
(10) Pub. No.: US 2009/0183636 A1
(43) Pub. Date: Jul. 23, 2009

(54) AIR PURIFIER DEVICE

(76) Inventors: Lawrence T. Levine, Fairfield, CT (US); Jay Packman, Montvale, NJ (US)

Correspondence Address: NORRIS, MCLAUGHLIN & MARCUS, 875 THIRD AVE, 18TH FLOOR, NEW YORK, NY, 10022, US

(21) Appl. No.: 11/718,669

(22) PCT Filed: Nov. 3, 2005
(86) PCT No.: PCT/GB05/04247

§ 371 Date: May 4, 2007

(30) Foreign Application Priority Data
Nov. 11, 2004 (GB) 0424882.9

(51) Int. Cl. B01D 46/42; B01D 46/00

(52) U.S. Cl. 96/397; 96/419

(57) ABSTRACT

The present invention is generally directed to devices useful in insuring the proper installation of a high efficiency particulate air (“HEPA”) filter into a room air purifier. In accordance with one aspect of the present invention, a magnetic interlock device is provided wherein the filter must be properly installed within the air purifier to enable closure of an electrical switch (74) within the air purifier, thereby completing an electrical circuit and permitting the air purifier motor and fan (20) to operate or to provide an audible or visual signal provided by electrically acuated means indicating incorrect placement of the filter within the device. In a second aspect of the invention, the air purifier is designed to create an audible signal to alert a user if the air purifier is operated without an air filter or if the air filter is improperly installed in the air purifier.

The present invention is generally directed to air purifier devices. More particularly, the present invention is directed to air purifier devices and high efficiency particulate air (“HEPA”) filters used in such purifier devices.

In recent years there has been a growing interest in improving environmental air conditions as the general ambient air has become more polluted. As more information is made available to consumers concerning environmental conditions, there has been an increased demand for products which can be used to effectively improve air quality, particularly within the home or office. As the number of airborne pollutants continues to increase, the effects upon the public have resulted in an increased number of complaints of respiratory infections, burning eyes, allergies, asthma attacks and other symptoms which are directly related to air pollution. One need only to consider the types of airborne particles which are inhaled by the average person on a daily basis to understand that the problem with airborne pollutants is ever increasing and its side effects growing. People are constantly inhaling particles of dust, smoke, pollen, molds, bacteria and the like.

Due to the ever increasing public awareness and the increasing health problems resulting from air pollution, an increasing demand has arisen for products which can be used by the general public to clean the air and improve air quality conditions in homes and places of employment. As a result, air purifiers for removing airborne particles are presently used in many homes and offices. Such purifiers often include a HEPA filter. In operation, these purifiers use one or more fans to cause air to be drawn into the purifier, through the filter to remove airborne particulates, and subsequently the filtered air is then emitted from the purifier through an outlet. HEPA filters have gained increasing acceptance for use in purifiers directed to consumers as they remove 99.97% of particles having a size equal to or greater than 0.3 microns.

Since HEPA filters arrest up to 99.97% of all particles, even the smallest amount of unfiltered air bypassing the HEPA filter and later mixing with the filtered air will bring the filtering efficiency down significantly. Thus, it is important to insure that the installation of the filter within the purifier is optimized and that no unfiltered air is permitted to bypass the filter. Because the filter employed in the the air purifier requires replacement when spent, the ability to easily remove and replace the filter is important. Critically, a filter must be properly aligned and installed within the purifier if it is to seal against unfiltered air bypassing the filter in order for the air purifier to function properly and achieve its maximum filtering efficiency.

One of the known disadvantages of prior art air purifiers is that the air filter can be easily misaligned or improperly installed into the air purifier by the consumer. This results in the phenomenon commonly known as “short-circuiting” wherein the air drawn into the air purifier will seek the path of least resistance and tend to flow around and bypass the filter, rather than pass through the filter, if the filter is not properly installed in the device. This results in less than satisfactory performance as the pollutants in the air are not removed by the filter but are emitted back into the ambient air.

While many air purifiers and air filters are known to the art and are described in the patent literature, there remains a real need for further improvements to such purifier/filter combinations. It is to such need and to such improvements that the present invention is directed.

In accordance with a first aspect of the invention, the air purifier is designed to create an audible signal to alert a user if the air purifier is operated without an air filter or if the air filter is improperly installed in the air purifier.

In accordance with a second aspect of the present invention, therein is provided a magnetically operated interlock device wherein the filter must be properly installed within the air purifier to enable closure of an electrical switch within the air purifier, thereby completing an electrical circuit and permitting the air purifier motor and fan to operate.

The present invention has overcome the aforementioned problem by utilizing either one or both of: (i) an arrangement whereby an audible signal is produced to alert the consumer that the air purifier is operating either without an air filter or with an air filter that has been improperly installed, and/or (ii) a magnetic interlock arrangement to prevent the consumer from operating the air purifier at all if a filter is not installed or if the filter is improperly installed within the air purifier housing.

### SUMMARY OF THE INVENTION

An air purifying device is provided for removing airborne particles. Such an air purifier generally includes a housing including an air inlet and an air outlet. A fan is positioned within the housing for drawing air into the interior of the housing through the air inlet and expelling filtered air through the air outlet. A filter assembly is positioned within an opening, within the housing, between the air inlet and the fan. The opening is configured to receive a filter assembly. The filter assembly includes a filter element, e.g, a folded or pleated type filter element, mounted within a frame or gasket such as a flexible foam gasket. In accordance with a first aspect of the invention, a portion of the housing of the air purifier, preferably at or near the opening of the housing, includes a vent hole or other passageway which contains a whistle or other instrument (e.g. a reed or a pair of reeds which may be vibrated, such as found in a harmonica). This instrument emits an audible sound when air is drawn into the passageway when the air purifier fan is operated and the filter assembly is either not installed or is improperly positioned within the housing by the user. Ideally, such a whistle or other reeded instrument will emit a sound within the audible frequency range for most persons (20 Hz-20 kHz) and be loud and/or of a high pitch so that it can plainly be heard by most persons above the operating noise of the air purifier fan.

In accordance with a second aspect of the invention, the filter assembly and housing of the air purifier together provide a magnetic interlock device. In this aspect, permanently affixed to a part of the housing, is provided a conventional electrical switch which is switchable between an open and a closed position. Such switching may occur as a direct result of the movement of a moveable post or one or more moveable elements forming part of the electrical switch, or switching may occur via movement of a lever arm forming part of the electrical switch. A permanent magnet may be affixed to the post of the electrical switch or, where the switch includes a lever arm, a permanent magnet may be permanently affixed on the lever arm preferably close to its moveable end. Concurrently, at an appropriate position in close proximity to the magnet associated with the electrical switch, there is embedded either within the filter element or within the frame or gasket, a ferous metal body or a magnet. Any form of a ferrous metal body may be used and embedded, e.g., an iron pin, disk, rod, wire or discrete particles such as pellets or filings, as long as such is of sufficient size to cause the electrical switch to be switched when the filter is properly installed within the opening of the housing. Similarly, when an embedded magnet is used, it is necessarily of sufficient strength and should be installed with appropriate polarity facing the magnet associated with the electrical switch so as to cause the electrical switch to be switched when the filter is properly installed within the opening of the housing. In use, when a removable filter assembly is properly installed in the housing, the electrical switch is switched responsive to the proximate location of the embedded ferrous body or embedded magnet, consequently closing or opening a circuit and allowing the motor and fan of the air purifier to operate.

In accordance with a third aspect of the invention, the filter assembly and housing of the air purifier together provide a magnetic interlock device. In this aspect, permanently affixed to a part of the housing is provided an electrical reed switch which is switchable between an open and a closed position responsive to the presence of a magnet or other magnetized body in sufficient proximity to the electrical reed switch causing it to open or close. The filter assembly according to this aspect of the invention is as described with reference to the second aspect of the invention, but desirably includes a magnet. In use, when a removable filter assembly is properly installed in the housing, the electrical reed switch is switched responsive to the proximate location of the embedded magnet or embedded magnetized body, consequently closing or opening a circuit and allowing the motor and fan of the air purifier to operate.

According to a fourth aspect of the invention, there is provided a filter assembly and housing of an air purifier which together provide a magnetic interlock device as generally described in accordance with the first, second and third aspects of the invention, but which differs in that the activation of the switch activates an indicator device which may be one or more electrically-actuated visual devices such as a lamp or LED, or one or more electrically-actuated audible devices such as a buzzer, siren bell or other tone generator, thereby providing a visual and/or audible indicator to the user of the device indicating incorrect installation of the filter or absence of the filter within the air purifier. According to this embodiment, the fan of the air purifier may operate independently of the magnetic interlock device, or alternately may be controlled by the magnetic interlock device.

According to a further aspect of the invention there is provided an air purifier device which includes the features according to one or more of the first, second or third aspects of the invention described herein.

Therefore, should the filter assembly be improperly installed within the opening of the housing of the air purifier by the user, either an audible signal will be emitted by the air purifier and/or the air purifier will not operate. In either instance, one or both of these conditions alert the user that the filter assembly is improperly installed within the air purifier and the filter assembly needs to be properly reinstalled within the housing for the air purifying device to work properly, or that a proper filter assembly is absent from the air purifier and needs to be properly installed.

These and other aspects of the present invention will be more apparent from the following description including the description of preferred embodiments as well as from a review of the accompanying drawings in which:

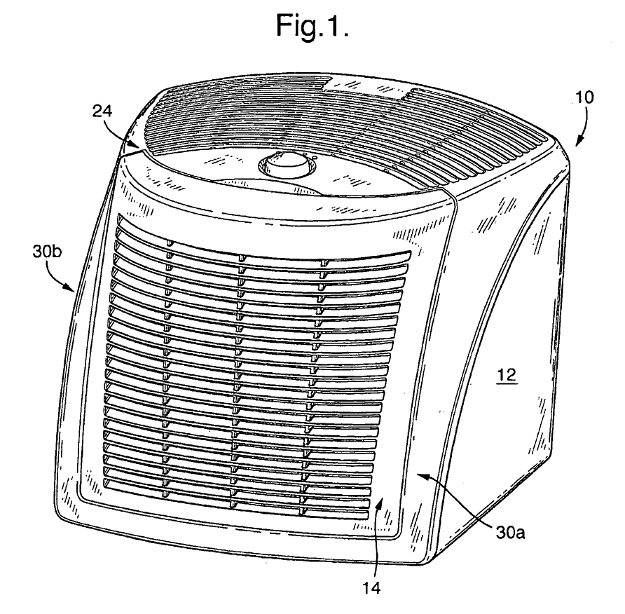

FIG. 1 is a front perspective view of a portable air purifier.

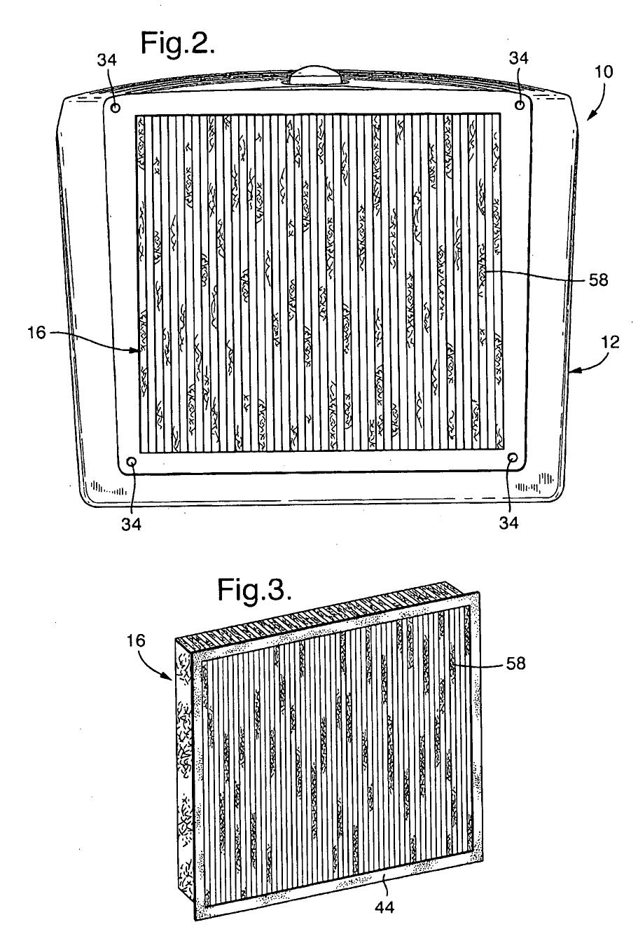

FIG. 2 is a front plan view of the air purifier with its front cover removed and a filter assembly installed within the housing of the air purifier.

FIG. 3 is a front perspective view of one embodiment of the filter assembly.

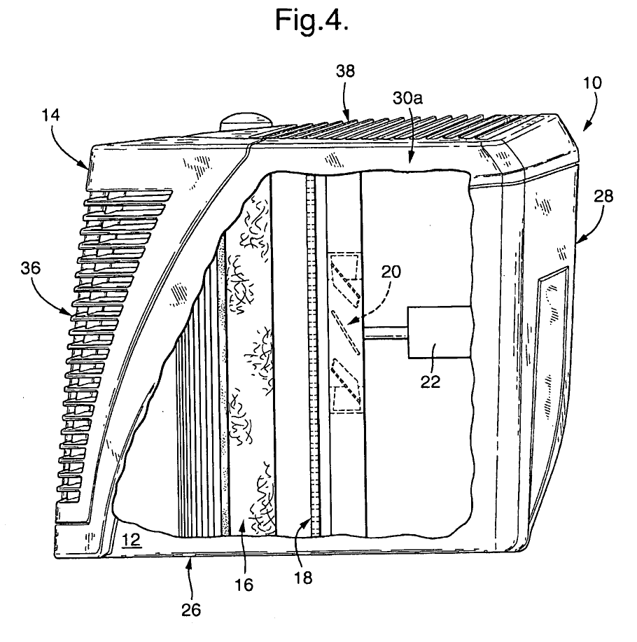

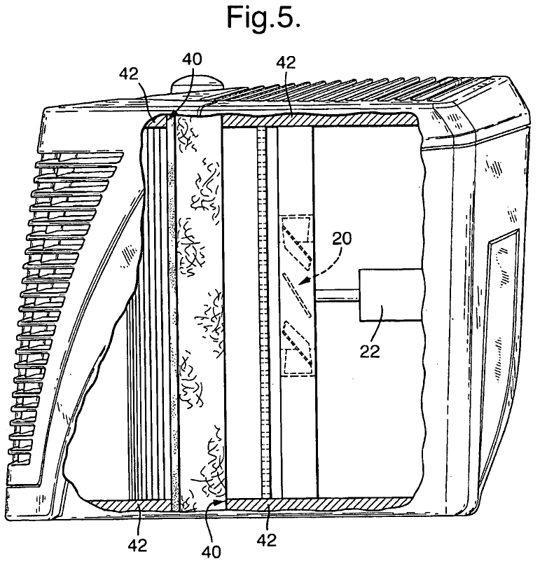

FIGS. 4 and 5 are left side views of the air purifier with a portion of its housing removed.

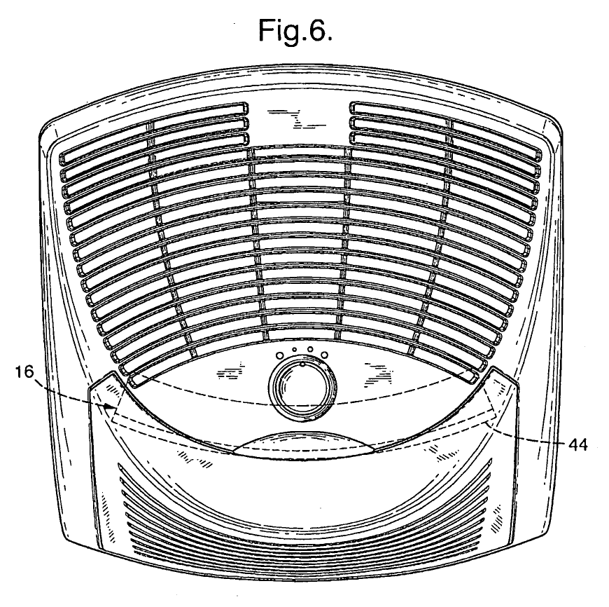

FIG. 6 is a top plan view of the air purifier with a portion of its housing removed.

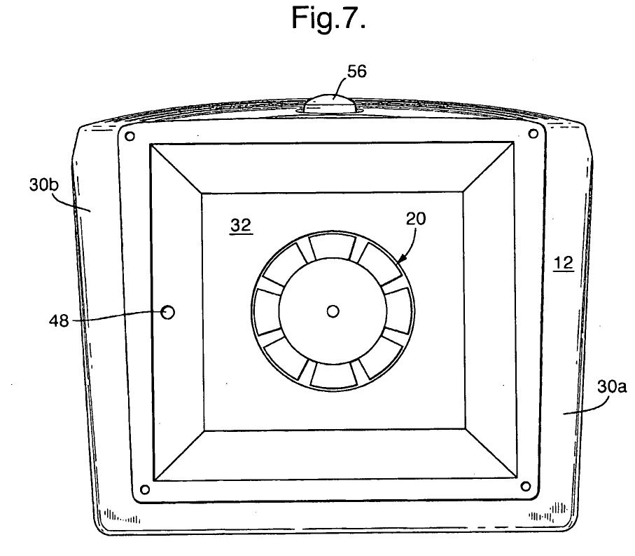

FIG. 7 is a front plan view of the air purifier with its front cover, filter assembly and safety cage removed.

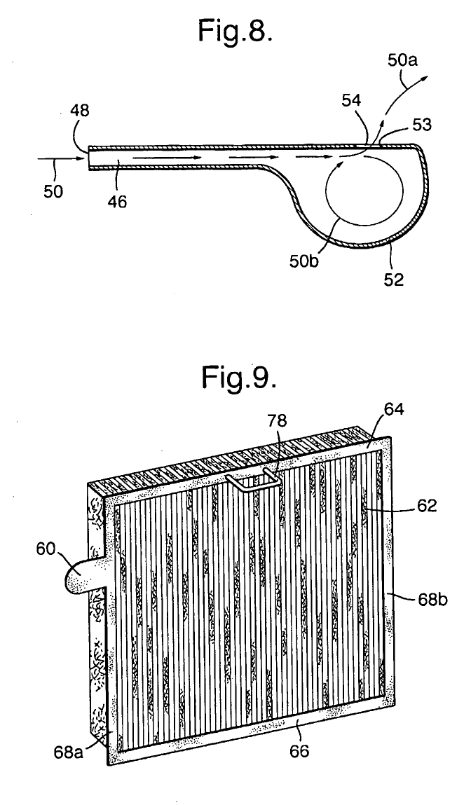

FIG. 8 is a schematic view of a device for creating an audible sound incorporated into the air purifier housing.

FIG. 9 is a front perspective view of a second embodiment of the filter assembly.

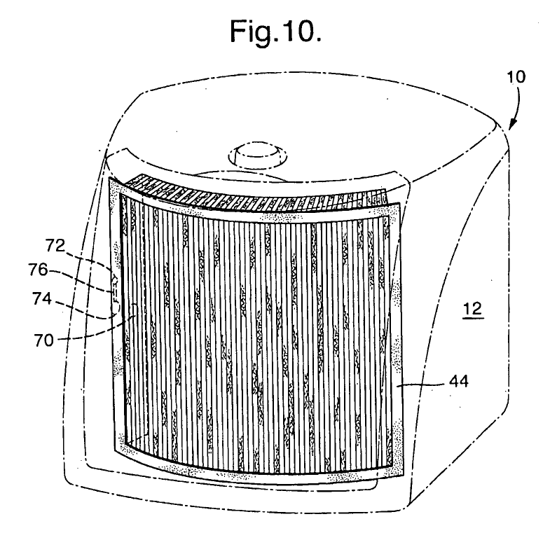

FIG. 10 is a front perspective view of the filter assembly installed within the air purifier housing.

It is believed that the present invention will be better understood from the following description of preferred embodiments, taken in conjunction with the accompanying drawings, in which like reference numerals identify identical elements throughout each of the figures.

### DETAILED DESCRIPTION OF A PREFERRED EMBODIMENT OF THE INVENTION

With initial reference to FIGS. 1 through 4, a portable air purifying device 10 in accordance with the present invention is depicted. The device generally comprises a housing 12, a front cover 14, a removable filter assembly 16, a safety cage 18, a fan 20 and an electrically driven motor 22.

Housing

Referring now to FIGS. 1, 2 and 4, the housing 12 comprises a top wall 24, a bottom wall 26, a rear wall 28 and opposed side walls 30a, 30b. The top wall, bottom wall and opposed side walls define an opening 32 (see FIG. 7) which is covered by a removable front cover 14. The front cover is held in its position across opening 32 by a plurality of tabs (not shown) which protrude from the inner surface of the front cover in a generally perpendicular orientation. The tabs are received in a corresponding plurality of holes 34 disposed in any or all of the top wall, bottom wall and opposed side walls which define the opening 32 of the housing. The removable front cover 14 has an air inlet 36 formed therein through which ambient air is drawn into the housing during operation of the fan 20. The top wall 24 of the housing 12 has an air outlet 38 through which air that has been drawn through the air inlet 36 and which has passed through the filter assembly 16 is expelled from the air purifying device. Preferably, both the air inlet 36 and the air outlet 38 are configured as a grill with a plurality of slot-like openings or is configured as a series of louvers formed therein. The removable front cover 14 is large enough to permit the filter assembly 16 to be removed from or inserted into the housing when the front cover is disengaged and removed from across the opening 32 of the device 10.

Referring now to FIG. 5, thereon is depicted the device 10 with a portion of its side wall 30a removed for purposes of illustration. It is observed that a recessed channel 40 is preferably molded integrally within the inner surfaces 42 of the top and bottom wall of the housing. While not illustrated, the opposed side walls 30a, 30b may also include a similar recessed channel. The recessed channel 40 is adapted and configured to receive the flexible foam gasket 44 and/or the filter element 58 of the filter assembly 16 and form an air tight seal therewith when the filter assembly is properly installed in the housing as hereinafter described. As depicted in FIG. 6, the portions of the channel 40 molded within the inner surfaces of the top wall and the bottom wall are preferably curvilinear in shape so that when filter assembly 16 is inserted into the channels, the filter assembly conforms and also takes a curvilinear shape.

Referring to FIGS. 7 and 8, at or near opening 32 of the housing 12 resides a tubular-shaped or rectangular-shaped, hollow airway 46 having at its one end an orifice 48 for receiving an ambient air stream 50 drawn through the air inlet 36 in the front cover 14 by means of the rotation of the fan 20, and at its opposite end a hollow confined space or cavity 52. Disposed within the cavity 52 is a sound hole 54, preferably small in proportion to the size of the cavity, where propelled air drawn into the cavity can thereafter exit the cavity. The sound hole has an edge or bevel 53 whose shape and placement will produce varying audible effects. An air stream is drawn into the orifice 48 and through the hollow airway 46 by means of the suction of ambient air into the device 10 due to the rotation of the fan 20. As this air stream 50 enters the cavity 52, it contacts the beveled edge 53 of the sound hole 54 whereupon the air stream splits. Some of the air stream 50a directly exits the sound hole while the remainder of the air stream 50b whirls about within the cavity 52 and vibrates and comes back out of the sound hole 54. The air stream escaping the cavity through the sound hole produces sufficient energy to produce an audible noise or whistle. This whistling sound will continue unabated as long as the fan 20 is operating unless and until the flow of the air stream through the sound hole is reduced or eliminated such as by covering the sound hole or the orifice 48, or by turning off the motor which drives the fan. While a whistle is shown and described, this audible sound need not be produced by a whistle but can instead be produced by any one or more of a variety of conventional methods including but not limited to the placement of one or more reeds within the airway 46 or cavity 52 in a manner such that the airsteam passing over the reed(s) will cause it to vibrate and produce an audible sound. Additionally, one or more small balls or other moveable elements may be placed within the interior of the cavity 52 whose movement within the cavity may provide a different character to the audible sound produced.

As described in more detail below, the purpose of producing such an audible sound is to alert the user either that: (a) the filter assembly is not inserted into the device 10 and that continued operation of the device in this manner will not produce the desired effect of removing particulate matter from the ambient air, or (b) that the filter assembly has been improperly seated into the housing 12, again resulting in the same undesirable effect.

In a further aspect of the present invention, referring to FIGS. 7 and 10, the housing contains in or proximate to one of side walls 30a, 30b, top wall 24 or bottom wall 26, preferably at or near the opening 32, an electrical switch 74 (e.g., a conventional SPST, DPDT switch, a reed switch or a microswitch) fixedly attached therein. The switch 74 is part of an electrical circuit controlling the operation of the motor 22 and fan 20 when the switch 74 is actuated and the air purifier is attached to a power source such as a battery or an electrical wall outlet. In the depicted embodiment, a permanent magnet 72 is attached to the switch itself, such as to a lever 76 forming part of the switch 74. The switch 74 is normally maintained in an open position (so that the electrical circuit is not completed) but is adapted to be moved to a closed position (so that the electrical circuit is completed) by a magnetic field from the permanent magnet 72 when a ferrous metal body or magnet is positioned in close proximity to the permanent magnet.

The housing 12 preferably will also accommodate a control knob 56 for adjusting the fan speed to control the flow of air into the housing through the air inlet 36 disposed in the front cover 14. Control of the fan speed may be by use of a conventional resistor block, or other solid state means for varying the rotational speed of the fan

The housing 12 and the removable front cover 14 are preferably made from a light weight durable material such as any of a number of synthetic thermoformable or thermosettable polymers which are preferably non-conductive and which are sufficiently rigid in order to maintain the shapes of the various elements used to construct the air purifier device. Exemplary synthetic polymers include polystyrene, polyalkylene terepthalates, polyamides, polysulfones, as well as other synthetic polymers not elucidated herein. Such synthetic polymers and blends may further include one or more additional filler and stiffening materials such as carbon fibers, glass fibers, glass beads and the like.

Filter Assembly

Referring to FIGS. 2 and 4, the filter assembly 16 is positioned within the housing 12 between the removable front cover 14 and the safety cage 18. As best seen in FIG. 3, the filter assembly 16 comprises a flexible foam gasket 44 disposed around the perimeter of a box-shaped filter element 58. While the box-shaped filter element may be of any shape or may be of any material which is satisfactory to permit the passage of air therethrough while filtering out undesired particulate materials present in the air, preferably the box-shaped filter element is formed of a pleated sheet of a filter material. Preferably the filter material is rated to meet or exceed current HEPA filtration performance standards. The box-shaped filter element 58 is bounded at one peripheral edge thereof by a foam gasket 44 which is preferably formed of a resilient or elastomeric material such as an expanded closed-cell polyurethane foam or the like. The gasket 44 is of sufficient resiliency to permit the filter assembly 16 to be flexed into a substantially convex shape (see FIG. 6) and thus fit into the mating shape of the channel 40 formed within the inner surfaces 42 of the top and bottom wall of the housing 12. A substantially air-tight seal is formed by the engagement of the gasket 44 and channel 40. Operation of the fan 20 tends to draw the gasket towards the channel, thereby enhancing the seal between the gasket 44 or the filter element 58 and the orifice 48 as hereinafter described. The gasket 44 generally includes a top wall 64, a bottom wall 66, and a first and second opposing side walls 68a,68b connecting the top and bottom walls. In one embodiment, the gasket is generally rectangular and follows the perimeter of the filter element 58. The gasket can be of any shape and size as long as it follows the perimeter of the filter element. Importantly, however, the gasket must be of sufficient dimensions to cover the orifice 48 when the filter assembly 16 is properly seated into channel 40.

In another embodiment, as shown in FIG. 9, when the foam gasket is formed it includes at least one “ear” or tab 60 protruding from at least one of the gasket walls or from a portion of the gasket. The tab is also flexible and resilient and is preferably constructed of the same material as the foam gasket. Most preferably the tab 60 is an integrated part of the gasket. The tab can be of any shape but it must be of sufficient size and dimensions to overlap and cover or sealingly engage orifice 48 when the filter assembly 16 is properly seated into channel 40. In this manner, air flow into orifice 48 is substantially reduced or eliminated such that the volume and velocity of the air stream 50 entering airway 46 is significantly reduced and the movement of the air stream 50 is of insufficient volume and velocity to cause the reeds to vibrate or to produce an audible noise when the air stream exits the sound hole 54. In use then, when the filter assembly 16 is properly installed into the air purifying device 10 by the user, no audible signal is produced which otherwise would alert the user that either there was no filter assembly 16 in the device 10, or that the filter assembly 16 was improperly installed.

Desirably, the filter element 58 portion of the filter assebly 16 is a high efficiency particulate air (“HEPA”) filter. The HEPA filter shown in FIG. 9 is comprised of a dense non-woven sheet of glass fibers held together with a binder and is constructed having a plurality of vertically extending parallel pleated portions 62. These pleats increase the effective surface area of the filter when compared to a filter having a smooth surface area. The filter element 58 is positioned within and connected to each of foam gasket walls 64, 66, 68a and 68b as shown in FIGS. 3 and 9. As illustrated in FIG. 10, in one embodiment a ferrous metal body 70, which is reactive to the magnet 72 attached to the switch 74, is attached to or alternately embedded within a pleat of the filter element 58. When the filter assembly 16 is properly oriented and positioned within the opening 32 of the housing 12, the ferrous metal body 70 will be in close proximity to the magnet 72. The magnet will react and activate the switch 74 by causing motion of the switch lever 76, thus closing the switch and completing the electrical circuit. When the filter assembly 16 is removed from the housing 12, or if the filter assembly is not properly oriented in the housing (such as by having the pleats 62 of the filter element oriented horizontally), the ferrous metal body 70 will be displaced amply away from the magnet 72 such that the magnet is no longer under the influence of its flux and the inherent switch properties counteract the previous motion of the switch. With the switch thus reverting to its open position, the electrical circuit is broken and the motor 22 and fan 20 will not operate. Alternately, the switch may be used to activate one or more electrically-actuated audible devices, e.g., a buzzer, siren, bell or other tone generator, thereby providing a visual and/or audible indicator to the user of the device. Similarly, a magnet may be used in the place of the ferrous metal body in order to provide a like result.

It is to be understood that the placement of the ferrous metal body 70 or magnet need not be limited to placement within or on the pleated portions 62 of the filter element 16. In a further embodiment the ferrous metal body could be placed within the foam gasket 44 either as a series of discrete ferrous particles or as a ferrous rod or wire. The important part is that the placement of the ferrous body 70, regardless of its shape, size, or placement on or within the filter element or gasket, be in sufficiently close proximity to the magnet 72 associated with the switch 74 when the air filter assembly 16 is oriented and positioned within the opening 32 of the housing 12, to cause the switch to move from its open position to its closed position, thus completing the electrical circuit and allowing the fan 20 and motor 22 within the air purifier to operate. The proximity between the magnet 72 and the ferrous metal body 70 at which the switch 74 will be actuated will vary depending upon the strength or flux of the magnet and the size of the ferrous metal body. It is contemplated, however, that the distance between the magnet and the metal body will be less than four inches, more preferably less than three inches, and most preferably less than two inches.

The filter assembly 16 of air purifier 10 is easily removed when the filter element 58 becomes soiled from the particulate matter captured by the filter element from the ambient air drawn into the housing 12. The front cover 14 is first removed and then the spent filter assembly 16 is removed from the channel 40 by pulling on, for example, a tab or ring 78 (see FIG. 9) which is integrated into the gasket 44. The top wall 64 of gasket is thus first removed from channel 40 whereupon the side walls 68a, 68b and bottom wall 66 of the gasket 44 are also removed from the channel. The new filter assembly is installed by flexing the bottom wall 66 of the gasket 44 so that the resulting contour fits into the curved channel portion 40 of the bottom wall 26 of housing 12. By applying nominal force to the side walls 68a, 68b of the filter assembly by pushing them towards one another and the housing, the side walls of filter assembly 16 will enter the housing. By then applying nominal force to the top wall 64 of the filter assembly, the top wall of the filter assembly will easily slide into the mating portions of the channel 40 disposed within the inner surface 42 of the top wall 24 of the housing. If the filter assembly 16 has been properly oriented within the housing 12, either the tab 60 or the foam gasket 44 or one of the pleated portions 62 of the filter element 58 itself will be covering the orifice 48 so that a whistling sound will not be produced, and the ferrous metal body 70 in or on the filter element 58 or the foam gasket 44 will be in close proximity to the magnet 72 mounted on the lever 76 of the switch 74 to cause the switch to move from ints normally open position to its closed position, thereby completing the electrical circuit and permitting the motor 22 and fan 20 to operate. According to a particularly preferred embodiment, the installed filter assembly 16 is necessarily arched from a flat or planar configuration, and it is particularly preferred that one edge of the installed filter assembly 16 forms a first arcuate edge, and the opposite edge of the installed filter assembly forms a second arcuate edge, wherein the radii of the first arcuate edge and the second arcuate edge is different.

Safety Cage

As shown in FIG. 4, within the housing 12 positioned between the filter assembly 16 and the fan 20 is a safety cage 18 that is removable and that preferably is configured as a grill with a plurality of slot-like openings or the like formed therein to permit air drawn into the housing through the air inlet 36 and which has passed through the filter element 58 to also be drawn through the safety cage. As with the air inlet and the air outlet, the particular shapes of the openings within the safety cage are not critical so long as they permit satisfactory throughput of air. The purpose of the safety cage is to prevent the motor and most importantly the fan, from coming into contact with a users fingers when the front cover 14 is removed and the filter assembly 16 is also removed, such as during the removal and replacement of the filter assembly. If a filter assembly 16 and housing 12 arrangement is employed wherein a magnetic switch 74 and ferrous metal body 70 arrangement is utilized as previously described, the motor 22 and fan 20 will not operate when the filter assembly is removed from the housing and hence a user's fingers will not be exposed.

Fan and Motor

Also within the housing 12, positioned between the safety cage 18 and the rear wall 28 of the housing is a centrifugal fan 20 driven by an electric motor 22. The fan 20 is positioned within the housing so that air is drawn through the air inlet 36 of the front cover 14, through the filter element 58 of the filter assembly 16, and then through the openings in the safety cage whereupon the now filtered air is subsequently exhausted through the air outlet 38 formed in the top wall 24 of the housing 12 as shown in FIG. 1.

The fan 20 can be of any type suitable of generating sufficient air movement to draw ambient air into the housing through the air inlet, then through the filter element, and then exhausting the filtered air out of the housing through the air outlet disposed in, for example, the top wall 24. Preferably the fan is of the type known in the art as a centrifugal or “squirrel cage” fan, although it can also be a propeller-type fan.

In operation, the control knob 56 on the housing 12 is turned by the user to select the desired fan speed. Rotation of the fan blades causes air to be drawn into the air inlet 36 and through the filter element 58. Since the filter assembly 16 restricts the airflow, considerable suction is created across the surface of the filter assembly 16 causing the filter assembly to be drawn into the housing 12 towards the safety cage 18. This force enhances the engagement of the gasket 44 within the channel 40 to ensure that unfiltered air does not bypass or short-circuit the filter assembly 16 prior to passing through the safety cage and exiting the housing through the air outlet 38.

Thus, in one aspect of the present invention, operation of the air purifying device 10 will be prevented if the filter assembly 16 containing a ferrous metal body or magnet is either not placed within housing 12 containing a switch and magnet arrangement as described or if the filter assembly is not properly oriented and positioned within the housing such that the ferrous metal body or magnet is displaced too far away from the magnet of the switch and the magnet cannot act upon the ferrous metal body or corresponding magnet. This is particularly advantageous in that it will prevent the by-pass of untreated and unfiltered air around the filter assembly.

Additionally, in a further aspect of the present invention, an audible sound such as a whistle will be generated if the air purifying device 10 is operated either without a filter assembly 16 or if the filter assembly is improperly aligned or installed within the housing 12 so that the orifice 48 is not covered. This is again particularly advantageous in that it alerts a user that either air is being circulated without any treatment or that untreated air is by-passing the filter assembly.

Yet further as has been briefly discussed above, the air purifying device 10 includes an indicator device which may be one or more electrically-actuated visual devices (e.g., a lamp or LED) or one or more electrically-actuated audible devices (e.g., a buzzer, siren, bell or other tone generator) thereby providing a visual and/or audible indicator to the user of the device indicating incorrect installation of the filter or absence of the filter.

The preferred embodiments of the present invention have been illustrated and described herein. However, it is to be understood that the present invention is not limited to the preferred embodiments described herein. Various alternatives and modifications can be devised by someone skilled in the art without departing from the invention. Accordingly, the present invention is intended to embrace all such alternatives, modifications and variances which fall within the scope of the appended claims.

1. An air purifier, comprising:
a housing defining an opening;
a motor mounted within said housing and connected to a power source;
a fan mounted within said housing and connected to said motor;
an electrical switch within a wall of said housing wherein said switch has a magnet associated therewith, and wherein the electrical switch is switchable between an open and a closed position;
a filter assembly comprising a filter element and a gasket, wherein a ferrous metal body or a magnet is affixed to said filter assembly;
characterized in that:
proper placement of said filter assembly within said opening causes the electrical switch to operate and consequently allows said motor to be activated by said power source and said fan to rotate, or consequently activating an electrically actuated indicator device.

2. The air purifier according to claim 1, wherein said ferrous metal body or magnet is affixed to said filter element.

3. The air purifier according to claim 1, wherein said ferrous metal body or magnet is affixed to said gasket.

4. The air purifier according to claim 1, wherein said switch comprises a lever arm, and a magnet being affixed to said lever arm.

5. The air purifier according to claim 1, wherein said ferrous metal body is selected from the group consisting of a pin, disk, rod, wire, pellets or filings.

6. An air purifier, comprising:
a housing defining an opening;
a motor mounted within said housing and connected to a power source;
a fan mounted within said housing and connected to said motor;
an airway within a wall of said housing, wherein said airway defines an orifice and contains a means for producing an audible sound when air is drawn into said airway by the rotation of said fan; and
a filter assembly;
characterized in that:
placement of said filter assembly within said opening covers said orifice so that said audible sound is not produced.

7. The air purifier according to claim 6, wherein said means for producing an audible sound is a whistle.

8. The air purifier according to claim 6, wherein said means for producing an audible sound is one or more vibrating reeds.

9. The air purifier according to claim 6, wherein said filter assembly comprises a filter element mounted within a gasket.

10. The air purifier according to claim 8, wherein said gasket comprises a tab portion.
